(19) United States
(12) Patent Application Publication
(10) Pub. No.: US 2025/0196694 A1
(43) Pub. Date: Jun. 19, 2025

(54) CHARGING EQUIPMENT AND CHARGING METHOD OF TREATING COMMUNICATION DELAY DURING CHARGING OPERATION

(71) Applicants: Hyundai Motor Company, Seoul (KR); Kia Corporation, Seoul (KR)

(72) Inventor: Young Sik Kim, Anyang-si (KR)

(21) Appl. No.: 18/743,739

(22) Filed: Jun. 14, 2024

(30) Foreign Application Priority Data
Dec. 18, 2023 (KR) 10-2023-0184035

(51) Int. Cl. B60L 53/66

(52) U.S. Cl. CPC B60L 53/66; B60L 2250/00

(57) ABSTRACT

An embodiment charging facility configured to treat a communication delay during a charging operation includes one or more processors and a storage device storing a program to be executed by the one or more processors, the program including instructions to determine whether the communication delay has occurred based on communication messages transmitted to and received from an electric vehicle at a start of the charging operation and reduce a charging current provided to the electric vehicle in response to a determination that the communication delay has occurred.

### CROSS-REFERENCE TO RELATED APPLICATIONS

This application claims the benefit of Korean Patent Application No. 10-2023-0184035, filed on Dec. 18, 2023, which application is hereby incorporated herein by reference in its entirety.

### TECHNICAL FIELD

The present disclosure relates to a charging facility and a method of treating communication delay during charging operations.

### BACKGROUND

Generally, while charging, an electric vehicle periodically sends a current demand request to the charging facility to request a charging current. The charging facility transmits a current demand response corresponding thereto to the electric vehicle. For example, the charging operation is performed while the electric vehicle and the charging facility periodically transmit and receive current demand requests and current demand responses to and from each other.

However, if the current demand response cannot be received due to communication delay due to noise or the like during charging, the electric vehicle repeatedly transmits a current demand request retransmission to the charging facility, and if a current demand response is not received from the charging facility within a predetermined timeout period, the electric vehicle may end the charging operation.

However, in this case, the driver may not recognize this situation, and there may be inconvenience in having to perform the charging operation again from the beginning.

### SUMMARY

An embodiment of the present disclosure provides a charging facility and method of treating communication delay during charging, in which a preemptive response is possible before an electric vehicle terminates a charging operation, and an inconvenience of having to perform the charging operation again from the beginning may be reduced.

According to an embodiment of the present disclosure, a charging facility treating a communication delay during a charging operation includes one or more processors and a storage medium storing computer-readable instructions. When the computer-readable instructions are executed by the one or more processors, the one or more processors are configured to determine whether the communication delay has occurred based on communication messages transmitted and received to and from an electric vehicle when charging begins and are configured to reduce a charging current provided to the electric vehicle when it is determined that a communication delay has occurred.

According to an embodiment of the present disclosure, a charging method of treating a communication delay during a charging operation includes a first operation of determining whether a communication delay has occurred based on communication messages transmitted and received from an electric vehicle when charging begins and a second operation of reducing a charging current provided to the electric vehicle when it is determined that a communication delay has occurred.

According to an embodiment of the present disclosure, a computer-readable storage medium on which a program for executing the method described above on a computer is recorded is provided.

### BRIEF DESCRIPTION OF THE DRAWINGS

The above and other aspects, features, and advantages of embodiments of the present disclosure will be more clearly understood from the following detailed description, taken in conjunction with the accompanying drawings, in which:

FIG. 1 is a diagram illustrating a charging system for an electric vehicle including a charging facility for treating communication delay during a charging operation according to an embodiment;

FIG. 2 is a block diagram related to charging equipment and charging of an electric vehicle for treating communication delay during a charging operation according to an embodiment;

FIG. 3 is a flowchart illustrating a charging method of treating a communication delay during a charging operation according to an embodiment; and

FIG. 4 is a block diagram of a computing device that may fully or partially implement a charging facility for treating communication delay during a charging operation according to an embodiment.

### DETAILED DESCRIPTION OF ILLUSTRATIVE EMBODIMENTS

Hereinafter, specific embodiments will be described with reference to the drawings. The detailed description below is provided to provide a comprehensive understanding of the methods, devices, and/or systems described herein. However, this is only an example and the present disclosure is not limited thereto.

In describing the embodiments, if it is determined that the detailed description of the known technology related to the present disclosure may unnecessarily obscure the subject matter of the present disclosure, the detailed description will be omitted. In addition, terms to be described later are terms defined in consideration of functions in the present disclosure, which may vary according to the intention or custom of a user or operator. Therefore, the definition should be made based on the contents throughout this specification. Terminology used in the detailed description is only for describing the embodiments and should not be taken as limiting. Unless expressly used otherwise, singular forms of expression include plural forms. In this description, expressions such as “including” and “comprising” are intended to indicate any characteristic, number, step, operation, element, portion, or combination thereof, and they should not be construed as excluding the existence or possibility of one or more other characteristics, numbers, steps, operations, elements, parts, or combinations thereof other than those described.

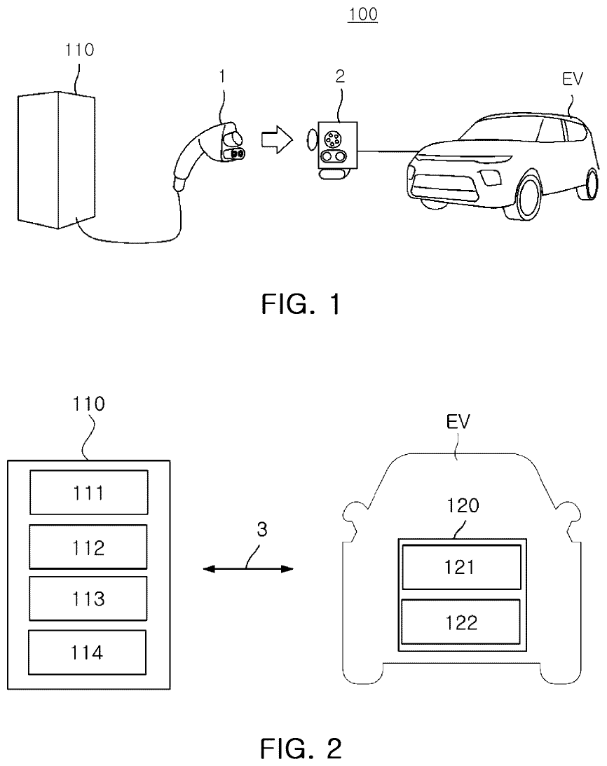

FIG. 1 is a diagram illustrating a charging system for an electric vehicle including a charging facility for treating communication delay during a charging operation according to an embodiment. FIG. 2 is a block diagram related to a charging facility and charging of an electric vehicle for resolving communication delay during charging operations according to an embodiment.

As illustrated in FIGS. 1 and 2, a charging system 100 may include a charging facility 110 and a charging device 120 provided in an electric vehicle EV.

In embodiments of the present disclosure, the electric vehicle includes a high-voltage battery 122 charged by the charging facility 110 and may include a plug-in hybrid electric vehicle (PHEV) in addition to a pure electric vehicle.

Additionally, the charging facility 110 may be provided with an outlet 1, and correspondingly, the electric vehicle EV may also be provided with an inlet 2. In addition, the charging facility 110 and the charging device 120 provided in the electric vehicle EV may perform communication 3 during the charging operation and may periodically transmit and receive communication messages. The communication 3 described above may be power line communication (PLC), but it should be noted that it is not necessarily limited to a PLC communication.

To resolve the above-mentioned communication delay, the charging facility 110 may include a processor (for example, a computer, microprocessor, CPU, ASIC, logic circuit, or the like) and a memory storing software instructions providing various functions when executed by the processor. In this case, the processor and the memory may be implemented as separate semiconductor circuits. Alternatively, the processor and the memory may be implemented as a single integrated semiconductor circuit. The processor may be one or more processors.

Hereinafter, the charging facility 110 and the charging device 120 of the electric vehicle EV will be described in detail.

The charging facility 110 may include a power supply unit 111, a control unit 112, a storage unit 113, and a communication unit 114.

The power supply unit 111 may provide a preset amount of charging current to the charging device 120 under the control of the control unit 112.

When charging begins, the control unit 112 may determine whether a communication delay has occurred based on communication messages transmitted and received to and from the electric vehicle EV.

The above-mentioned communication messages may include a current demand request received from the electric vehicle EV during a charging operation, a current demand response sent to the electric vehicle EV by corresponding to the current demand request, and a current demand request retransmission sent by the electric vehicle EV when the current demand response is not received.

For example, during charging, the electric vehicle EV periodically transmits a current demand request requesting charging current to the charging facility 110, and the charging facility 110 transmits a corresponding current demand response to the electric vehicle EV. For example, the charging operation is performed while the electric vehicle EV and the charging facility 110 periodically transmit and receive current demand requests and current demand responses to and from each other.

However, if the current demand response cannot be received due to a communication delay caused by noise during charging, the electric vehicle EV repeatedly transmits a current demand request retransmission to the charging facility 110 at regular intervals. If a current demand response is not received from the charging facility 110 within a predetermined timeout period, the electric vehicle EV may end the charging operation.

On the other hand, the control unit 112 may determine a communication delay based on the number of times a current demand request retransmission is received during a predetermined timeout period or whether a current demand request is received during a predetermined timeout period.

In this case, the timeout period may be shorter than a timeout period set for the charging device 120 of the electric vehicle EV.

Alternatively, the timeout period may be shorter than the standard timeout period set by the international standards organization.

In detail, according to an embodiment of the present disclosure, when the current demand request retransmission is received a preset number of times during the timeout period from the time of receiving the current demand request retransmission, or when the current demand request is not received again during the timeout period from the last time the current demand request was received, the control unit 112 may determine that a communication delay has occurred.

If it is determined that a communication delay has occurred, the control unit 112 may control the power supply unit 111 to reduce the charging current provided to the electric vehicle EV.

According to an embodiment, the control unit 112 may reduce the magnitude of the charging current to the magnitude of the charging current at the time the current demand request was last received.

According to another embodiment, the control unit 112 may gradually reduce the magnitude of the charging current to a certain ratio (for example, 10%) of the magnitude of the charging current at the time the current demand request was last received.

Thereafter, the control unit 112 may send a charging delay notification due to a communication delay to the user.

On the other hand, the storage unit 113 may store various programs and data to implement the functions performed by the control unit 112 described above.

The communication unit 114 may be a device for transmitting and receiving the above-described data to and from the electric vehicle EV under the control of the control unit 112 or for sending a charging delay notification to the user.

On the other hand, the charging device 120 may include a charging device 121 and a battery 122.

In detail, the charging device 121 may charge the battery 122 with the charging current provided by the charging facility 110.

In addition, the charging device 121 may periodically transmit a current demand request requesting charging current to the charging facility 110 during charging and may receive a current demand response from the charging facility 110.

In addition, when the charging device 121 is unable to receive a current demand response due to a communication delay caused by noise during charging, the charging device 121 repeatedly transmits a current demand request retransmission to the charging facility 110 at regular intervals. If a current demand response is not received from the charging facility 110 within a predetermined timeout period, the electric vehicle EV may end the charging operation.

As described above, according to an embodiment, if it is determined that a communication delay has occurred due to noise during the charging operation, by reducing the charging current provided to the electric vehicle to eliminate communication obstacles, a preemptive response is possible before the electric vehicle terminates charging operations, and thus the inconvenience of having to perform the charging operation again from the beginning may be reduced.

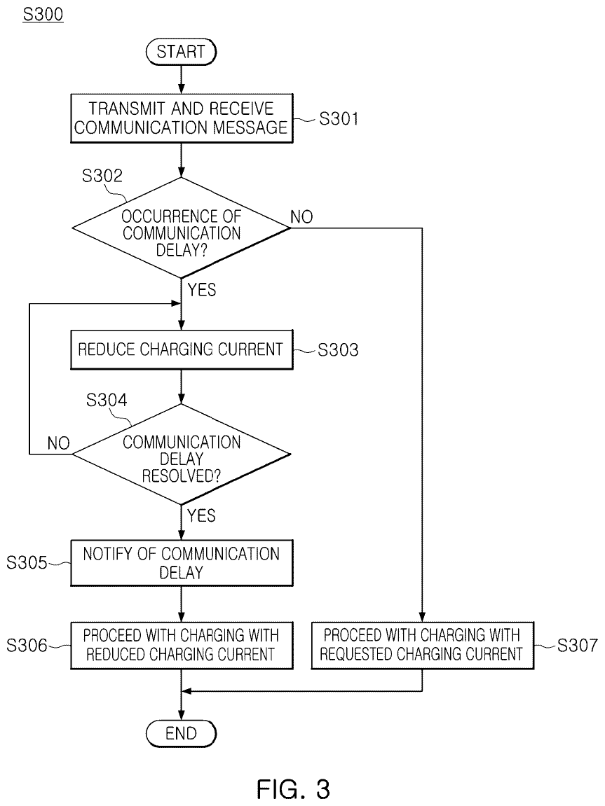

On the other hand, FIG. 3 is a flowchart illustrating a charging method of treating a communication delay during a charging operation according to an embodiment.

Hereinafter, a charging method of treating a communication delay during a charging operation according to an embodiment will be described with reference to FIGS. 1 to 3. However, for simplification of the descriptions, descriptions overlapping with FIG. 1 are omitted.

Referring to FIGS. 1 to 3, a charging method (S300) of treating a communication delay during a charging operation according to an embodiment may begin with the operation of transmitting and receiving a communication message during a charging operation (S301).

In detail, during charging, the electric vehicle EV periodically transmits a current demand request requesting charging current to the charging facility 110, and the charging facility 110 transmits a corresponding current demand response to the electric vehicle EV. For example, the charging operation is performed while the electric vehicle EV and the charging facility 110 periodically transmit and receive current demand requests and current demand responses to each other.

Afterwards, the charging facility 110 may determine whether a communication delay has occurred due to noise (S302).

In this case, the charging facility 110 may determine a communication delay based on the number of times a current demand request retransmission is received during a predetermined timeout period or whether a current demand request is received during a predetermined timeout period. In this case, as described above, the timeout period may be shorter than the timeout period set for the charging device 120 of the electric vehicle EV or may be shorter than the standard timeout period set by the international standards organization.

According to an embodiment, when the charging facility 110 receives the current demand request retransmission a preset number of times during the timeout period from the time of receiving the current demand request retransmission, or when the current demand request is not received again during the timeout period from the last time the current demand request was received, it may be determined that a communication delay has occurred.

If it is determined that a communication delay has not occurred, the charging facility 110 may control the power supply unit 111 to proceed with charging with the charging current requested by the electric vehicle EV (S307).

If it is determined that a communication delay has occurred, the charging facility 110 may control the power supply unit 111 to reduce the charging current provided to the electric vehicle EV (S303).

According to an embodiment, the control unit 112 may reduce the magnitude of the charging current to the magnitude of the charging current at the time the current demand request was last received.

According to another embodiment, the control unit 112 may gradually reduce the magnitude of the charging current to a certain ratio (for example, 10%) of the magnitude of the charging current at the time the current demand request was last received.

Next, the charging facility 110 may determine whether the communication delay due to noise has been resolved (S304). For example, when the charging facility 110 receives a current demand request from the electric vehicle EV again, it may be determined that the communication delay has been resolved.

When the communication delay is resolved, the charging facility 110 may send a notification of charging delay due to the communication delay to the user (S305).

Thereafter, the charging facility 110 may proceed with charging the electric vehicle EV with a reduced charging current (S306).

As described above, according to an embodiment, when it is determined that a communication delay has occurred due to noise during the charging operation, by reducing the charging current provided to the electric vehicle to eliminate communication obstacles, a preemptive response is possible before the electric vehicle terminates charging operations, and thus the inconvenience of having to perform the charging operation again from the beginning may be reduced.

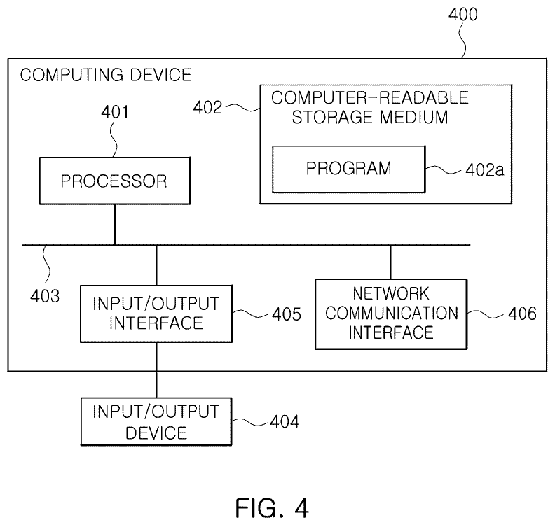

FIG. 4 is a block diagram of a computing device 400 that may fully or partially implement the charging facility 110 to resolve communication delay during charging operations according to an embodiment.

As illustrated in FIG. 4, the computing device 400 includes at least one processor 401, a computer-readable storage medium 402, and a communication bus 403.

The processor 401 may enable the computing device 400 to operate according to the example embodiments mentioned above. For example, the processor 401 may execute one or more programs 402a stored in the computer-readable storage medium 402. The one or more programs 402a may include one or more computer-executable instructions, and the computer-executable instructions, when executed by the processor 401, may be configured to cause the computing device 400 to perform operations according to example embodiments.

The computer-readable storage medium 402 is configured to store computer-executable instructions or program code, program data, and/or other suitable forms of information. The program 402a stored in the computer-readable storage medium 402 includes a set of instructions executable by the processor 401. In an embodiment, the computer-readable storage medium 402 may be a memory (a volatile memory, such as a random access memory, a non-volatile memory, or an appropriate combination thereof), one or more magnetic disk storage devices, optical disk storage devices, flash memory devices, other forms of storage media that may be accessed by the computing device 400 and store required information, or a suitable combination thereof.

The communication bus 403 interconnects various other components of the computing device 400, including the processor 401 and the computer-readable storage medium 402.

The computing device 400 may also include one or more network communication interfaces 406 and one or more input/output interfaces 405 providing an interface for one or more input/output devices 404. The input/output interface 405 and the network communication interface 406 are connected to the communication bus 403. The network may be any one of cellular networks, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), a Universal Mobile Telecommunications System (UMTS), Long Term Evolution (LTE), or other cellular networks.

The input/output device 404 may be connected to other components of the computing device 400 through the input/output interface 405. As an example, the input/output device 404 may include input devices such as pointing devices (such as a mouse, a trackpad, or the like), keyboards, touch input devices (such as a touchpad, a touch screen, or the like), voice or audio input devices, various types of sensor devices and/or imaging devices, and/or output devices such as display devices, printers, speakers, and/or network cards. The illustrative input/output device 404 may be included within the computing device 400, as a component constituting the computing device 400, or it may be connected to the computing device 400 as a separate device distinct from the computing device 400.

On the other hand, embodiments of the present disclosure may include a program for performing the methods described in this specification on a computer and a computer-readable recording medium containing the program. The computer-readable recording medium may include program instructions, local data files, local data structures, and the like, singly or in combination. The medium may be those specifically designed and constructed for embodiments of the present disclosure, or the medium may be those commonly available in the computer software field. Examples of the computer-readable recording medium include magnetic media such as hard disks, floppy disks, and magnetic tapes, optical recording media such as a CD-ROM and DVD, and a hardware device specially configured to store and execute program instructions, such as ROM, RAM, flash memory, and the like. Examples of the programs may include not only machine language code such as that produced by a compiler, but also high-level language code that may be executed by a computer using an interpreter or the like.

As set forth above, according to an embodiment, when it is determined that a communication delay has occurred due to noise during a charging operation, the communication delay may be resolved by reducing the charging current provided to an electric vehicle, such that a preemptive response is possible before the electric vehicle ends the charging operation, and the inconvenience of having to perform the charging operation again from the beginning may be reduced.

While example embodiments have been shown and described above, it will be apparent to those skilled in the art that modifications and variations could be made without departing from the scope of the present disclosure as defined by the appended claims.

What is claimed is:

1. A charging facility configured to treat a communication delay during a charging operation, the charging facility comprising:
one or more processors; and
a storage device storing a program to be executed by the one or more processors, the program including instructions to:
determine whether the communication delay has occurred based on communication messages transmitted to and received from an electric vehicle at a start of the charging operation; and
reduce a charging current provided to the electric vehicle in response to a determination that the communication delay has occurred.

2. The charging facility of claim 1, wherein the communication messages comprise a current demand request received from the electric vehicle during the charging operation, a current demand response transmitted to the electric vehicle by corresponding to the current demand request, and a current demand request retransmission transmitted by the electric vehicle in a case in which the current demand response is not received.

3. The charging facility of claim 2, wherein the current demand request, the current demand response, and the current demand request retransmission are transmitted periodically.

4. The charging facility of claim 2, wherein the program further includes instructions to determine the communication delay based on a number of times the current demand request retransmission is received during a predetermined timeout period or based on whether the current demand request is received during the predetermined timeout period.

5. The charging facility of claim 4, wherein the program further includes instructions to determine that the communication delay has occurred based on the current demand request retransmission being received a preset number of times during the timeout period from a time of receiving the current demand request retransmission or based on the current demand request not being received again during the timeout period from a time at which the current demand request was last received.

6. The charging facility of claim 4, wherein the timeout period is shorter than a timeout period set for a charging device of the electric vehicle.

7. The charging facility of claim 4, wherein the timeout period is shorter than a standard timeout period set by an international standards organization.

8. The charging facility of claim 2, wherein the program further includes instructions to reduce a magnitude of the charging current to the magnitude of the charging current at a time the current demand request was last received.

9. The charging facility of claim 2, wherein the program further includes instructions to gradually reduce a magnitude of the charging current to a certain ratio of the magnitude of the charging current at a time the current demand request was last received.

10. The charging facility of claim 1, wherein the program further includes instructions to send a charging delay notification due to the communication delay to a user.

11. A charging method of treating a communication delay during a charging operation, the charging method comprising:
determining whether the communication delay has occurred based on communication messages transmitted to and received from an electric vehicle at a start of the charging operation; and
reducing a charging current provided to the electric vehicle in response to a determination that the communication delay has occurred.

12. The charging method of claim 11, wherein the communication messages comprise a current demand request received from the electric vehicle during the charging operation, a current demand response transmitted to the electric vehicle by corresponding to the current demand request, and a current demand request retransmission transmitted by the electric vehicle when the current demand response is not received.

13. The charging method of claim 12, wherein the current demand request, the current demand response, and the current demand request retransmission are transmitted periodically.

14. The charging method of claim 12, wherein determining whether the communication delay has occurred is based on a number of times the current demand request retransmission is received during a predetermined timeout period or based on whether the current demand request is received during the predetermined timeout period.

15. The charging method of claim 14, wherein the determination that the communication delay has occurred is based on the current demand request retransmission being received a preset number of times during the timeout period from a time of receiving the current demand request retransmission or based on the current demand request not being received again during the timeout period from a time at which the current demand request was last received.

16. The charging method of claim 14, wherein the timeout period is shorter than a timeout period set for a charging device of the electric vehicle.

17. The charging method of claim 14, wherein the timeout period is shorter than a standard timeout period set by an international standards organization.

18. The charging method of claim 12, wherein reducing the charging current comprises reducing a magnitude of the charging current to the magnitude of the charging current at a time the current demand request was last received.

19. The charging method of claim 12, wherein reducing the charging current comprises gradually reducing a magnitude of the charging current to a certain ratio of the magnitude of the charging current at a time the current demand request was last received.

20. The charging method of claim 11, further comprising sending a charging delay notification due to the communication delay to a user.
